(19) United States
(12) Patent Application Publication
(10) Pub. No.: US 2023/0015396 A1
(43) Pub. Date: Jan. 19, 2023

(54) ENERGY DAMPENING SYSTEMS

(71) Applicant: DarkMatter Sciences, LLC, Rochester, NY (US)

(72) Inventors: Brett E. Maurer, Rochester, NY (US); David A. Rumold, Rochester, NY (US)

(21) Appl. No.: 17/863,933

(22) Filed: Jul. 13, 2022

Related U.S. Application Data
(60) Provisional application No. 63/222,235, filed on Jul. 15, 2021.

(51) Int. Cl. F16F 9/30; B32B 5/18; B32B 7/12; B32B 5/32; B32B 5/02; B32B 27/30; B32B 27/12; B32B 27/06; B32B 37/06; B32B 37/10; B32B 3/08; F41H 5/04

(52) U.S. Cl. CPC F16F 9/306; B32B 5/18; B32B 7/12; B32B 5/32; B32B 5/02; B32B 27/302; B32B 27/12; B32B 27/065; B32B 37/06; B32B 37/10; B32B 3/085; F41H 5/0478; B32B 2262/0261; B32B 2266/0278; B32B 2266/124; B32B 2307/558; B32B 2307/536; B32B 2307/732; B32B 2571/02; F16F 2224/02; F16F 2226/042; F16F 2228/001; F16F 2222/12; F41H 1/02

(57) ABSTRACT

Energy dampening and/or dispersing systems may include a gel member having a top surface and a bottom surface, an aerated gel member having a top surface and a bottom surface, and the top surface of the aerated gel member secured to the bottom surface of the gel member. In some embodiments, the energy dampening and/or dispersing systems may include a support structure secured to the gel member, and a cover extending over the top surface of the support structure and the bottom surface of the aerated gel member. The energy dampening and/or dispersing systems may be operable in ballistic garments, footwear, sporting goods, and vehicles.

### CROSS REFERENCE TO RELATED APPLICATIONS

This application claims the benefit of U.S. Provisional Patent Application No. 63/222,235, filed Jul. 15, 2021, entitled ENERGY DAMPENING SYSTEMS, the entirety of which is incorporated herein by reference.

### FIELD OF THE DISCLOSURE

The present disclosure relates generally to dampening and/or dispersing of energy, and more particularly to energy dampening and/or dispersing systems such as for use in ballistic garments, footwear, vehicles, sporting goods and the like.

### BACKGROUND

Body armor is protective clothing designed to absorb or deflect physical attacks. Typically, there are two main types of body armor, soft and hard. Soft armor is typically non-plated body armor for moderate to substantial protection and includes such things as KEVLAR or other pliable ballistic fabrics. Hard armor may include hard-plate reinforced body armor for maximum protection, such as that used by combat soldiers. Rigid ballistic armor plates, also known as rifle plates, are cloth covered plates of ballistic material, such as hardened steel, ceramic composites, or thermally formed and bonded layered ballistic fabric. Armor plates may be used as inserts in specialized garments called plate carriers or plate carrier systems that suspend and position the plate on the wearer's body at a desired location.

High velocity projectiles, such as bullets, and lower velocity projectiles, such as fragments and associated shrapnel, have a tangible transfer of pressure/force when impacting an object, such as a ballistic armor plate. A ballistic pressure wave (and associated wave force) is generated at impact and transmitted through the ballistic armor plate and into the body of the wearer. Typical armor systems focus on preventing penetration of the projectile, but do not address the effects of the resultant pressure wave.

For example, when the projectile impacts the front of the armor plate, the back of the plate sits (albeit perhaps separated by a few layers of clothing) against the wearer's body. Even though the armor plate stops the projectile, which takes time and distance, the armor plate is deformed backward toward the body. How much it is deformed depends on the protective level of the armor plate and the energy of the projectile. The heavier the projectile is and the faster it is going, the more energy (and force) is delivered to the plate. The distance of deformation is commonly referred to as “back face deformation” (BFD). This BFD can lead to “behind armor blunt trauma” (BABT) which can, by itself, be lethal.

BABT is a non-penetrating injury caused by the rapid deformation of an armor plate by a projectile. The energy delivered to the armor plate by the projectile is kinetic energy and causes blunt force trauma to the tissue behind the projectile's impact on the plate. That blunt force trauma caused by the energy that is delivered through the plate material and into the body behind it can cause injuries such as bruises, broken bones, lacerations, abrasions and, in extreme circumstances, can cause death. Thus, while it is imperative to prevent penetration by a projectile, it is no less important to mitigate the energy/force imparted to the body through projectile impacting the armor plate.

Blunt force trauma resulting from impacts to the body are also found outside of the armed combat arena. For instance, a large number of motor vehicle accidents involve blunt force trauma to the driver and/or passenger(s). Athletes are also prone to blunt force injuries, particularly in contact sports such as football, rugby and hockey where participants violently collide with one another during the course of play. Protective gear has been developed, but again, this gear is primarily directed to providing protection from the initial impact and does not address or alleviate the associated pressure/force transmitted to the body as a result of that impact.

Current measures attempting to alleviate the effects of blunt force trauma focus on the use of polymer foam layers positioned between the outer layer of worn equipment and the wearer's body. The foam merely provides a greater distance between to back face of the armor plate and the body. Thus, the back face deformation may not directly impact the body to cause injury. However, the pressure/force transfer is not sufficiently mitigated by these foams. The problem is that these foam layers use outgassing when compressed to dissipate energy. This outgassing is inefficient and recharge time (the time it takes to return the foam to its original resting state) may be impermissibly long for some applications. Also, for high impact energies, a thicker foam layer on the order of 10-12 inches may be needed to satisfactorily dampen and disperse the transferred energy. This thickness may be prohibitive for implementation in real-world devices. Moreover, outgassing foams may be suitable for some applications, but are wholly unsuitable for localized point impacts, such as when struck by a fired projectile. Rather, the area of foam engaged by the projectile is too small for the resultant outgassing to slow, dissipate or otherwise mediate the energy as the energy passes through the foam and into the underlying body tissue.

Dilatant, shear-thickening and non-Newtonian materials have also been developed to address impact pressures/forces. However, these materials are typically single-use materials which need to be replaced after an impact event. While this may be acceptable for certain applications, such materials are unsuitable for situations involving multiple or repeated impacts.

Thus, it can be seen that there is a need for a thinner, lighter and stronger energy dampening and/or dispersing system that can be used across a wide range of equipment, such as and without limitation to ballistic armor applications, outdoor equipment, footwear, athletic apparel, athletic protective gear and the like. There is also a further need for an energy dampening and/or dispersing system that can be used in load bearing systems with fast (nearly instantaneous) system reset or return-to-form capability for use in applications such as, but not limited to, ruck/backpack straps, carrier straps, and other load bearing support structures. The present disclosure satisfies these, as well as other, needs.

### SUMMARY

Energy dampening and/or dispersing systems may reduce dangerous transferred energy and help prevent follow on injuries to the wearer during a life-threatening event. The unique layering of selected materials in specific orientation combine to dampen and/or disperse energy and dissipate impact forces across the timeline of the given impact event. Armor packages coupled with energy dampening and/or dispersing systems (or abbreviated to simply “energy dampening systems” for clarity and simplicity) of the present disclosure greatly increase protection against transmitted energies of impact particularly in local regions sensitive to hydrostatic, stress wave and shear impact forces.

The technique of the present disclosure may include use in a variety of products for use as an energy dampening system. Some other applications include vehicles, sporting goods such as sporting protective equipment, healthcare products, and other products.

Shortcomings of the prior art are overcome and additional advantages are provided through the provision, in one embodiment of an energy dampening system having, for example, a gel member having a top surface and a bottom surface, an aerated gel member having a top surface and a bottom surface, and the top surface of the aerated gel member being secured to the bottom surface of the gel member.

In another embodiment, an energy dampening system includes, for example, a rigid member having a top surface and a bottom surface, a molecular gel member having a top surface and a bottom surface, the top surface of the molecular gel member secured to the bottom surface rigid member, an aerated gel member having a top surface and a bottom surface, the top surface of the aerated gel member secured to the bottom surface of the molecular gel member, and a cover extending over the top surface of the rigid top member and the bottom surface of the aerated gel member.

In another embodiment, a method for dispersing kinetic energy includes, for example, providing the energy dampening system as described above, receiving a force applied to the energy dampening system, and distributing the force through the energy dampening system.

In another embodiment, a method for dispersing kinetic energy includes, for example, providing a pair of the energy dampening systems as described above in footwear and between the footwear and the feet of the wearer of the footwear, and distributing forces from the feet of the wearer through the energy dampening system.

In another embodiment, a method for forming an energy dampening system includes, for example, providing a gel member, providing an aerated gel member, providing an adhesive layer between the gel member and the aerated gel member, applying heat and a compressive force to an outer surface of the gel member and the aerated gel member, trimming a peripheral edge of the compacted members, and sealing the trimmed peripheral edge of the compacted members.

### BRIEF DESCRIPTION OF THE DRAWINGS

The subject matter which is regarded as the disclosure is particularly pointed out and distinctly claimed in the concluding portion of the specification. The disclosure, however, may best be understood by reference to the following detailed description of various embodiments and the accompanying drawings in which:

FIG. 1 is a cross-sectional view of an exemplary energy dampening and/or dispersing system in accordance with an embodiment of the present disclosure;

FIG. 2 is a cross-sectional view of an alternative exemplary energy dampening and/or dispersing system in accordance with an embodiment of the present disclosure;

FIG. 3 is a perspective phantom view of a bullet proof vest equipped with an exemplary energy dampening and/or dispersing system in accordance with an embodiment of the present disclosure;

FIG. 4 is cross-sectional view of an exemplary energy dampening and/or dispersing system positioned within a shoe in accordance with an embodiment of the present disclosure;

FIG. 5 is a cross-sectional view of another alternative exemplary energy dampening and/or dispersing system in accordance with an embodiment of the present disclosure;

FIG. 6 is a top plan view of an exemplary embodiment of the alternative exemplary energy dampening and/or dispersing system shown in FIG. 5;

FIG. 7 is a top plan view of an alternative exemplary embodiment of the alternative exemplary energy dampening and/or dispersing system shown in FIG. 5;

FIG. 8 is a cross-sectional view of the exemplary embodiment of the alternative exemplary energy dampening and/or dispersing system shown in FIG. 5;

FIG. 9 is a cross-sectional view of a bullet proof vest equipped with the exemplary embodiment of the alternative exemplary energy dampening and/or dispersing system shown in FIG. 5;

FIG. 10A-10E show comparative IMPACT FORCE data for different projectiles impacting a bullet proof vest with ballistic plate and a bullet proof vest with ballistic plate and an exemplary energy dampening and/or dispersing system;

FIG. 10F is a table compiling the IMPACT FORCE data from FIGS. 10A-10E,

FIG. 11 is a flowchart illustrating a method for dispersing kinetic energy, according to an embodiment of the present disclosure;

FIG. 12 is a flowchart illustrating a method for dispersing kinetic energy, according to an embodiment of the present disclosure;

FIG. 13 is flowchart illustrating a method for forming an energy dampening and/or dispersing system, according to an embodiment of the present disclosure; and

FIG. 14 is flowchart illustrating a method for forming an energy dampening and/or dispersing system, according to an embodiment of the present disclosure.

### DETAILED DESCRIPTION

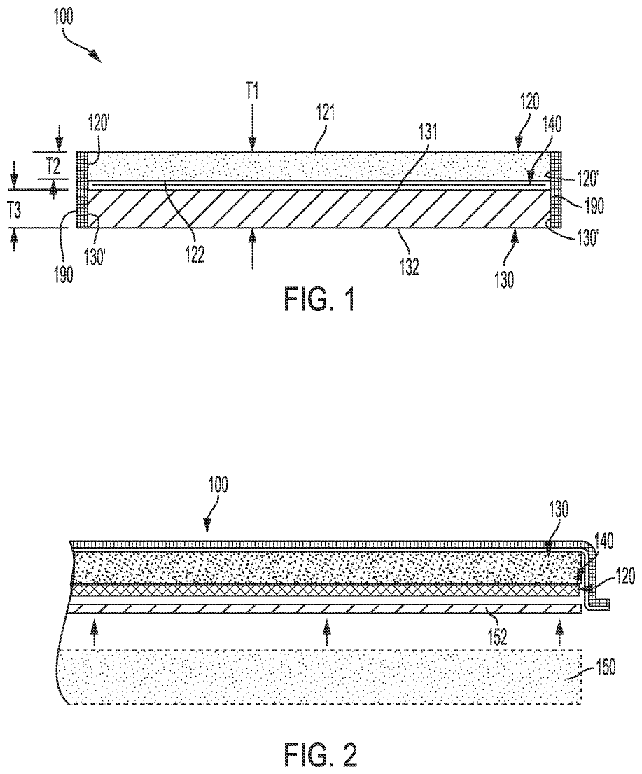

FIGS. 1 and 2 illustrates an energy dampening and/or dispersing system (or more simply, energy dampening system) 100, according to an embodiment of the present disclosure. In this illustrated embodiment, energy dampening system 100 may include a gel member 120 and an aerated gel member 130. Gel member 120 may include a top surface 121 and a bottom surface 122. Aerated gel member 130 may include a top surface 131 and a bottom surface 132. Top surface 131 of aerated gel member 130 may be coupled to bottom surface 122 of gel member 120, such as for example, via an adhesive or adhesive layer 140. Energy dampening system 100 may also be secured to an underlying support structure 150, such as via a second adhesive 152. Underlying support structure 150 may be a rigid (e.g., ABS, metal, etc.) or semi-rigid (canvas, ballistic fibers, reinforce polymer materials, etc.) material. Energy dampening system 100, with or without underlying support structure 150, may be incorporated into, by way of example and without limitation thereto, ballistic armor, outdoor equipment, footwear, athletic apparel, athletic protective gear and the like.

By way of example and without limitation thereto, gel member 120 may be constructed of polyurethane gel, and more particularly may be constructed of polyurethane gel incorporating dry viscoelastic materials therein. One non-limiting example of a suitable gel member 120 material may be SHOCKtec Gel material available from Shocktec, Inc., Mooresville, N.C. Similarly, aerated gel member 130 may be constructed using an air-frothed polyurethane gel, and more particularly may be constructed using an air-frothed polyurethane gel which incorporates dry viscoelastic materials therein so as to resemble a foam material but retain the performance characteristics of a gel, as described in greater detail below. One non-limiting example of a suitable aerated gel member 130 material may be SHOCKtec Air2Gel material available from Shocktec, Inc., Mooresville, N.C.

In accordance with an aspect of the present invention, in some embodiments, the combination of gel member 120 and aerated gel member 130 may be operable to better disperse forces acting initially on gel member 120 or initially on the aerated gel member 130 depending upon which member is facing the impact source.

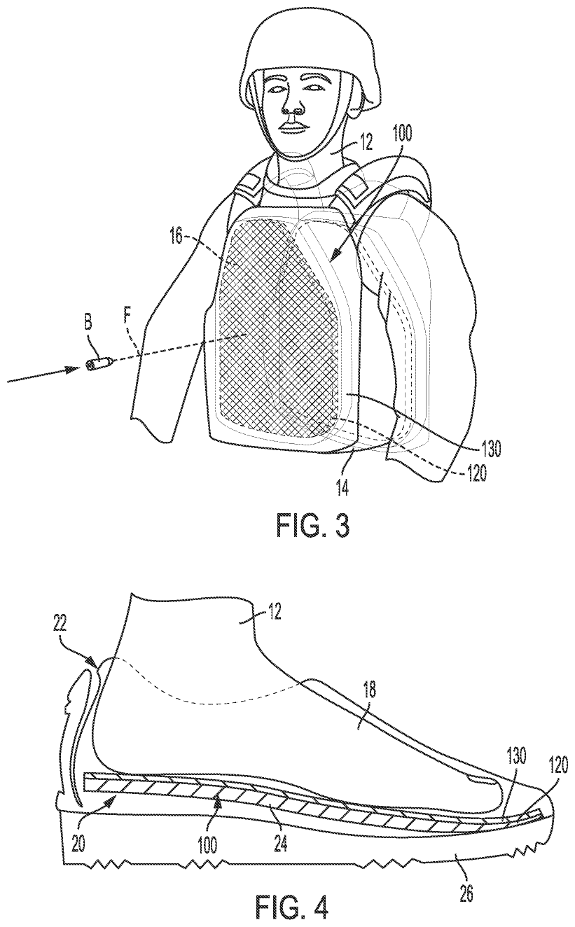

In other embodiments, the combination of gel member 120 and aerated gel member 130 may be operable to better disperse forces acting initially on gel member 120 and transferring forces through aerated gel member 130 to the outer surface or bottom surface 132 of aerated gel member 130. By way of example and with reference to FIG. 3, when employed in conjunction with a plate carrier system 14 (often referred to colloquially as a “bullet proof vest”) having an armor plate 16, energy dampening system 100 may be oriented such that gel member 120 is positioned adjacent the armor plate while the aerated gel member 130 lies adjacent the body of wearer 12. For systems including a support structure 150, support structure 150 is positioned adjacent armor plate 16 while aerated gel member 130 lies adjacent the body of wearer 12. As a result, a fired projectile B (e.g., bullet) will first strike the armor plate 16 which will then cause energy (and back face deformation of the plate) to impact support structure 150 and second adhesive 152 (if used) and then gel member 120. Gel member 120 may then disperse all or a large portion of the force/energy F transferred to energy dampening system 100 before any residual energy impacts the inner aerated gel member 130. The interiorly oriented aerated gel member 130 may then dissipate the remainder of the energy such that the projectile impact imposes little, if any, localized or blunt force to the wearer 12.

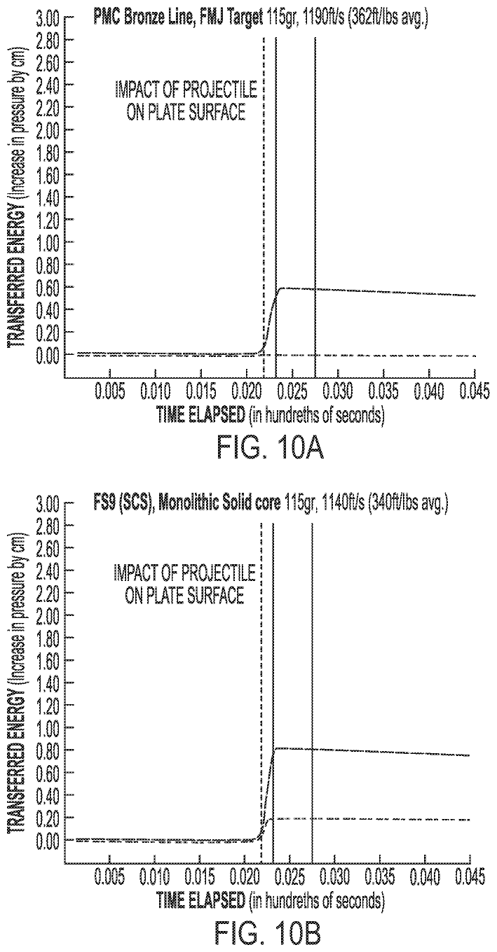

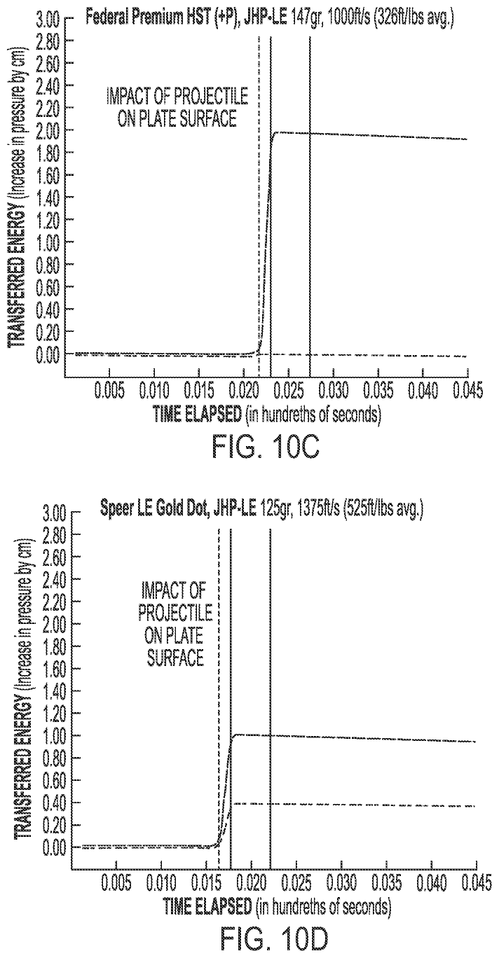

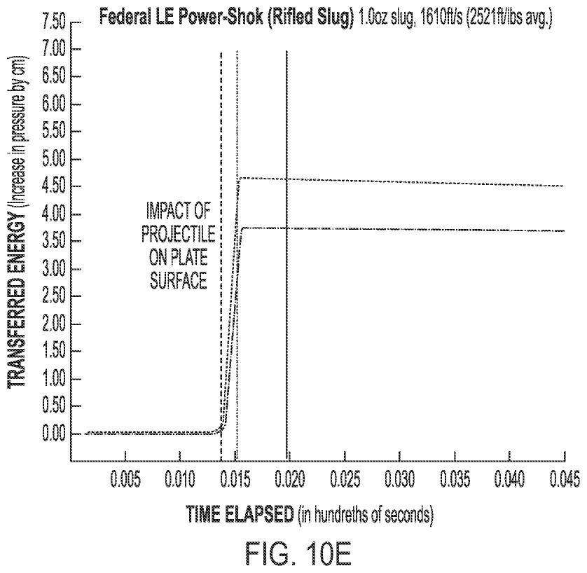

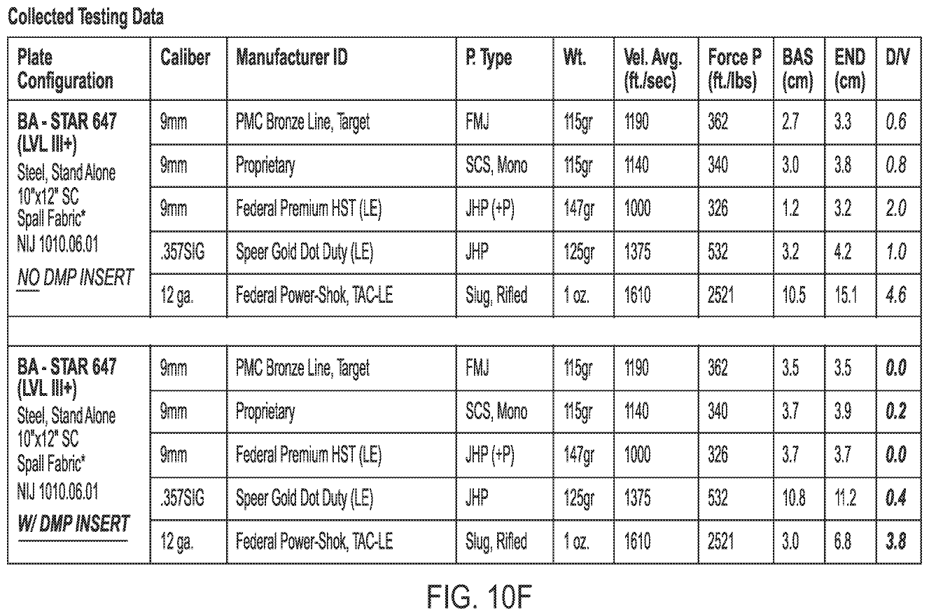

As will be described in greater detail below with regard to FIG. 10, and without being restricted to any one particular theory, it is believed that when focalized energy is delivered to gel member 120, such as through a projectile impact, a portion of the energy wave propagates along gel member 120 to the edges of gel member 120 such that the energy is dispersed across the gel member whereby the magnitude of energy transmitted by the gel member is diluted and diminished. A portion of the focalized energy may also pass through gel member 120 to impact aerated gel member 130. Again, most, if not all, of the energy transferred to aerated gel member 130 would propagate along aerated gel member 130 towards the edges of aerated gel member 130. Thus, the initial focalized energy impacting energy dampening system 100 is dissipated by gel member 120 and aerated gel member 130 such that the wearer experiences a greatly reduced, if any, energy impact from the projectile. Inclusion of adhesive layers may also attenuate the pressure/energy wave passing through the members, thereby further mitigating energy transfer and any resultant injury to the wearer.

In accordance with another aspect of the present invention, because gel member 120 and aerated gel member 130 are formed as gels and not foams, energy dispersion is managed through energy wave propagation through each of the member layers and not through outgassing of air as in traditional foam. Further, the gel materials of gel member 120 and aerated gel member 130 experience less compression than foam counterparts and also exhibit much faster recharge times than foam. In one aspect, recharge times for gel member 120 and aerated gel member 130 may be on the order of milliseconds or less while comparable foam materials may have a recharge time approaching tens of seconds. As a result, energy dampening system 100 is especially suitable for use in situations involving frequent, i.e., near instantaneous, impacts, such as but not limited to repeated projectile impacts resulting from repeated discharging a firearm.

In other embodiments, the combination of gel member 120 and aerated gel member 130 may be operable to better disperse forces acting on aerated gel member 130 and transferring forces through gel member 120 to the outer surface or top surface 132 of gel member 120. By way of example and with reference to FIG. 4, when configured as an insert or insole 20 of an article of footwear 22, gel member 120 may be placed adjacent the inner surface/sole 24 of the footwear bottom 26 while the aerated gel member 130 lies adjacent the foot 18 when worn. Without being restricted to any particular theory, it is believed that a wearer's footfall (e.g., step) will cause foot 18 to engage aerated gel member 130 which can then disperse all or a large portion of the step energy before any residual energy is imparted to gel member 120. Gel member 120 may then dissipate the remainder of the energy such that the wearer experiences little, if any, localized or blunt force while walking/running.

In some embodiments, either or both of gel member 120 and/or aerated gel member 130 may be configured to transfer forces primarily in one or more directions. For example, the gel member may be configured to more readily transfer forces in one direction compared to other directions. For example, the gel member 120 and/or aerated gel member 130 may have baffles or a varying gel densities or materials. In some embodiments, aerated gel member 130 may be configured to transfer forces primarily in one or more directions. Gel member 120 and aerated gel member 130 may be oriented relative to each other to transfer forces in the same direction through the energy dispersal system 100. In other embodiments, such gel member and aerated gel member may be oriented at the same angle, at a perpendicular angle, or at other angles relative to each other to transfer forces in different direction across and/or through the energy dispersal system 100. Thus, forces may be transferred differently across one or both of the gel member and the aerated gel member. The forces may be transferred differently through one or both of the gel member and aerated gel member.

As described below, during manufacture, the gel member may be disposed in tension and the aerated gel member may be disposed in tension along the mating surface of the gel member and the aerated gel member. In other embodiments, the aerated gel member may be disposed in tension and the gel member may be disposed in tension along the mating surface of the gel member and the aerated gel member.

Energy dampening system 100 may have a planar configuration, a contoured or curved configuration, e.g., concave or convex configuration, along the outer surfaces, or other suitable configurations such as to match or conform to portions of a person such a person's chest or foot, or to match and conform to other components or parts of a machine or other device.

With reference to FIG. 1, gel member 120 and aerated gel member 130 may have aligned peripheral edges 120′, 130′, respectively, and may further include a seal 190 secured to the peripheral edges. Energy dampening system 100 may have a thickness T1, such as but not limited to about 0.5 inch. Gel member 120 may have a thickness T2, such as but not limited to about 0.125 inch while aerated gel member 130 may have a thickness T3, such as but not limited to about 0.18 inch. Adhesive layer 140 may impart a nominal thickness, such as but not limited to less than about 100 microns (0.0039 inches).

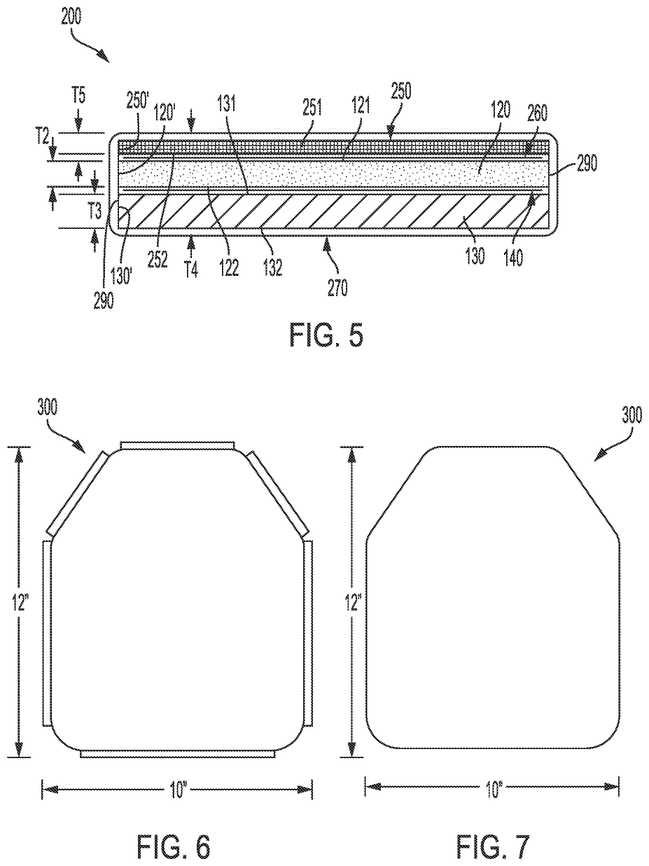

Turning now to FIG. 5, there is illustrated an alternative embodiment of an energy dampening system 200 in accordance with the present disclosure. In this illustrated embodiment, energy dampening system 200 may include a support structure 250, gel member 120, aerated gel member 130, and a cover 270. Support structure 250 may include a top surface 251 and a bottom surface 252 and may be comprised of a rigid (e.g., plastic, composite, ceramic, metal, etc.) or semi-rigid (canvas, ballistic fibers, reinforced polymer, woven, etc.) material. Gel member 120 may include a top surface 121 and a bottom surface 122. Aerated gel member 130 may include a top surface 131 and a bottom surface 132. Bottom surface 252 of support structure 250 may be secured to top surface 121 of gel member 120, for example, with an adhesive 260. Bottom surface 132 of gel member 120 may be secured to top surface 131 of aerated gel member 130, for example, with an adhesive 140. Cover 270 may be disposed and extend over top surface 251 of support structure 250 and bottom surface 132 of aerated gel member 130, such as to encapsulate layers 120, 130, 140 and 250 to form a substantially dustproof and/or watertight construction.

As described in greater detail below, in some embodiments, the combination of support structure 250, gel member 120, and aerated gel member 130 may be operable to better disperse forces initially acting on support structure 250 and transferring forces through support structure 250, through gel member 120, and through aerated gel member 130 to the outer surface or bottom surface 132 of aerated gel member 130 than foam-based counterparts.

In some embodiments, support structure 250, gel member 120, and/or aerated gel member 130 may also be configured to transfer forces primarily in one or more directions such as along a plane or through the thickness. For example, support structure 250 may be a composite material having fibers disposed in a single direction, or in a plurality of directions. Gel member 120 may also or alternatively be configured to more readily transfer forces in one direction compared to other directions. In some embodiments, aerated gel member 130 may also or alternatively be configured to transfer forces primarily in one or more directions. For example, aerated gel member may be configured to more readily transfer forces in one direction compared to other directions.

Support structure 250, gel member 120 and aerated gel member 130 may also be oriented relative to each other to transfer forces in the same direction through the energy dispersal system 200. In other embodiments, such support structure 250, gel member 120 and aerated gel member 130 may be oriented at the same or different angles relative to each other to transfer forces in different directions across and/or through the energy dispersal system 200. Thus, forces may be transferred differently across one or all of the support structure 250, gel member 120 and/or aerated gel member 130.

As described below, during manufacture, the support structure 250, gel member 120 and/or aerated gel member 130 may be disposed in tension or compression compared to the other members which may be in compression or tension along corresponding mating surfaces. In other embodiments, gel member 120 may be disposed in tension or compression relative to support structure 250, and aerated gel member 130 may be disposed in tension or compression along the mating surface of gel member 120 and the aerated gel member 130.

Energy dampening system 200 may have a planar configuration, a contoured or curved configuration, e.g., concave or convex configuration, along the outer surfaces, or other suitable configurations such as to match or conform to portions of a person 12 such a person's chest or foot 18, or to match and conform to other components or parts of a machine or other device.

Support structure 250, gel member 120, and aerated gel member 130 may have aligned peripheral edges 250′, 120′, 130′, respectively, and may further include a seal 290 secured to the peripheral edges. Energy dampening system 200 may have a thickness T4, such as but not limited to about 0.5 inch. Support structure 250 may have a thickness T5, such as but not limited to about 0.062 inch, gel member 120 may have a thickness T2, such as but not limited to about 0.125 inch while aerated gel member 130 may have a thickness T3, such as but not limited to about 0.18 inch. Cover 270 may have a thickness of about 0.1 inch. Each of adhesive layers 140 and 260 may impart a nominal thickness, such as but not limited to less than about 100 microns (0.0039 inches) each.

In accordance with an aspect of the present invention, support structure 250 may be formed from any suitable material, such as and without limitation thereto, a rigid material comprising fiber reinforced plastic material such as an acrylonitrile-butadiene-styrene (ABS) plastic material, carbon fiber, and the like, or a semi-rigid material, such as canvas, ballistic fibers, reinforce polymer materials. Cover 270 may be any suitable material, such as but not limited to ripstop nylon fabric, natural or synthetic rubber, canvas, and the like.

FIGS. 6-9 illustrate an energy dampening system 300 sized and configured for use behind a ballistic plate in accordance with an exemplary embodiment of the present disclosure. Energy dampening system 300 may be configured and manufactured similarly to energy dampening system 200 described above. As will be appreciated the various embodiments of the present disclosure may provide energy dampening and/or dispersal systems such as trauma systems that may be worn underneath body armor/plate carrier systems. The energy dispersal systems may be operable to dampen/disperse the kinetic energy of a bullet when the bullet hits the armor/plate carrier system, whereby the armor plate prevents penetration of the bullet while the energy dispersal system mitigates back face deformation and energy transfer resulting from the bullet impact so that the bullet strike does not cause the wearer massive bodily harm or long-term injury.

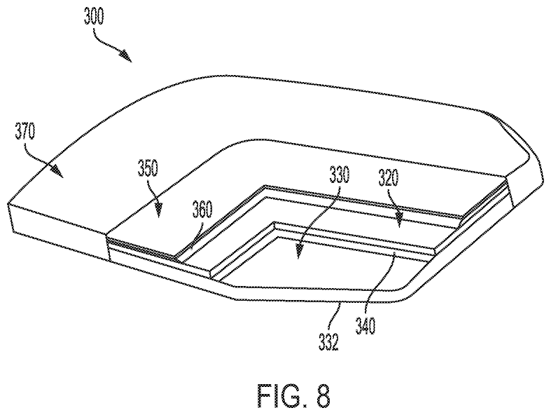

For example, as shown in FIG. 8, energy dampening system 300 may include a rigid support structure 350, gel member 320, an aerated gel member 330, and a cover 370. Rigid support structure 350 may include a top surface and a bottom surface. A bottom surface of rigid support structure 350 may be secured to a top surface gel member 320, for example, with an adhesive 360. A bottom surface of gel member 320 may be secured to a top surface of aerated gel member 330, for example, with an adhesive 340. Cover 370 may be disposed and extend over the top surface of rigid support structure 350 and a bottom surface 332 of aerated gel member 330.

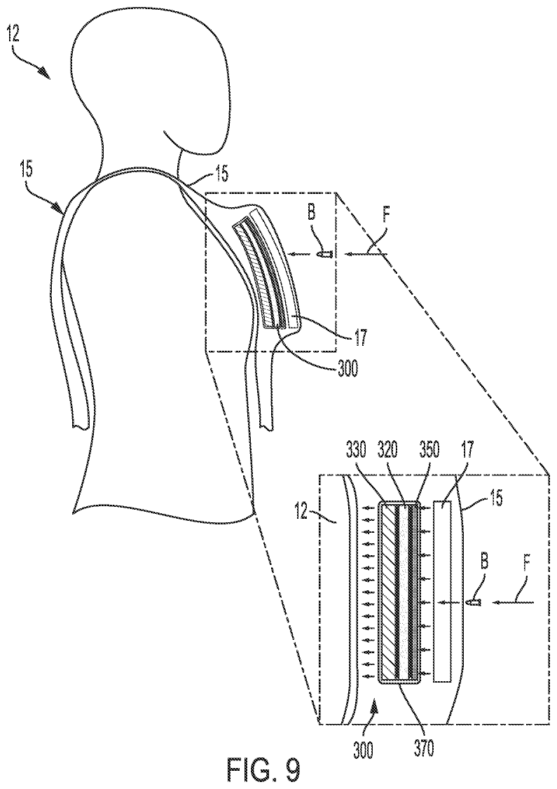

FIG. 9 illustrates a protective garment 15 having an energy dampening system 300 selectively insertable/removable behind a ballistic plate 17 when protective garment 15 is operably positioned or worn on a person 12. Similar to FIG. 3 described above, when energy dampening system 300 is employed in conjunction with ballistic plate 17, rigid support structure 350 is placed adjacent the ballistic plate 17 while the aerated gel member 330 lies adjacent the body of wearer 12. As a result, a fired projectile B (e.g., bullet) will first strike the ballistic plate 17 which will then cause force/energy (and back face deformation of the plate) to impact energy dampening system 300. Rigid support structure 350 will receive and transfer the impact energy to gel member 320. Gel member 320 may then disperse all or a large portion of the force/energy F before any residual energy impacts the inner aerated gel member 330. The interior oriented aerated gel member 330 may then dissipate the remainder of the energy such that the projectile impact imposes little, if any, localized or blunt force to the wearer 12.

FIGS. 10A through 10E show impact force plots for different projectiles when fired at a plate carrier system equipped with either a ballistic plate only or a ballistic plate and energy dampening system 400 in accordance with an embodiment of the present disclosure. FIG. 10F is a table showing a compilation of the data presented in FIGS. 10A through 10E.

FIG. 10A shows impact force data for a PMC Bronze Line (9 mm) projectile which was selected to represent the characteristics of a standard full metal jacketed (FMJ) ammunition. FMJ bonded core projectiles are prevalent in use across the nation as well as internationally, and represent the largest group of commonly encountered ballistics by LE/MIL individuals. Physical tendencies of FMJ rounds include a propensity to “over-penetrate” due to the projectile's nature to lack expansion upon impact. While these projectiles tend to be of simple, conventional design, they do not dump kinetic energy through the fanning or opening of the delivered projectile into a target object (i.e. armor plate, soft tissue, etc.) but rather tend to “drive” upon impact shedding energy as they travel.

FIG. 10B shows impact force data for a unique monolithic 9 mm projectile (FS9) which was selected to represent the characteristics of an alternative 9 mm ammunition. The FS9 ammunition is a monolithic, solid copper spun (SCS) projectile. It is designed to “tumble” (i.e. “yaw”) upon impact wherein the rear mass of the bullet flips over and towards the initial focal point of impact. Corroborated in rifle ballistics, this “tumble” creates increased terminal effectiveness in soft tissue at average rifle impact velocities.

FIG. 10C shows impact force data for a Federal Premium HST (+P) (9 mm) projectile which was selected as the premier line of duty and personal defense ammunition. HST is an industry recognized design standard for modern, current world jacketed hollow point (JHP) ammunition. Additionally the HST-LE (Law Enforcement) variant is (+P) designated allowing a look into energy dispersal data as it relates to “overpressured” ammunition and increased pressure delivery at point of impact by advanced ballistic projectiles.

FIG. 10D shows impact force data for a Speer LE Gold Dot (.357SIG) projectile which was selected as another commonly utilized projectile across multiple calibers in the LE market. The selected caliber choice of .357SIG was selected to provide data or caliber ranges outside of the standard 9 mm that distribute increased impact force upon impact due to increased velocities of the load which may provide insight into the effect of increased transferred energy and resultant BABT trauma.

FIG. 10E shows impact force data for a Federal Power-Shok (12 Ga.) projectile. Following initial testing of common handgun rounds (<1400 ft./s., <600 ft./lbs) (see FIGS. 10A-10D), the shotgun weapons platform, chambered in 12 gauge, was selected to evaluate the interaction of impact forces in long barreled (+14.5 in) delivery systems and their associated increase in delivered energies upon impact. Of note, the 1 oz. rifled slug delivers a projectile mass at slower velocity than long barreled rifle platforms utilized in law enforcement and military practices, however the interacting mass is of great consequence in this circumstance as a 12 Ga. Slug, relative to significantly lighter weight (low mass/high velocity) projectiles such as 5.56×45 NATO (M855 or XM193) and/or 7.62×39, delivers a mass payload at impact that reacts and drives transfer of energy very differently than the lighter, faster rifle designs.

As can be seen in FIG. 10F, the amount of energy transferred through the plate carrier system to the wearer is significantly reduced when the plate carrier system includes the energy dampening system 400. Comparing the differences in transferred energy (D/V) value for each projectile, it can be seen that energy reduction of plate carrier system plus energy dampening system 400 for most common handgun projectiles (such as 9 mm and other projectiles delivering foot pound force in a range, for example, of 326-362 ft./lbs) may be about 94 percent greater than the ballistic plate alone (see FIGS. 10A-10C), about 60 percent greater for high velocity handgun projectiles (such as .357SIG and other projectiles delivering foot pound force, for example, of 532 ft./lbs) (see FIG. 10D), and about 18 percent greater for large mass projectiles (such as shotgun slugs and other projectiles delivering foot pound force, for example, of 2521 ft./lbs) (see FIG. 10E).

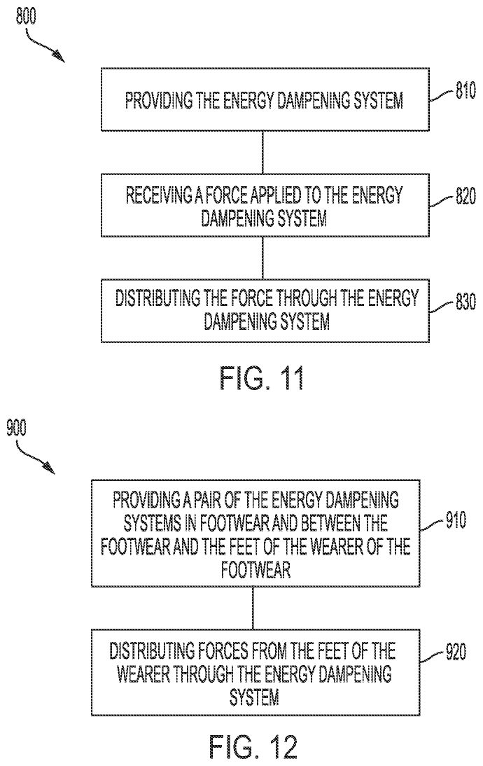

FIG. 11 illustrates a method 800 for dispersing kinetic energy, according to an embodiment of the present disclosure. Method 800 may include at 810 providing the energy dampening system as described above, at 820 receiving a force applied to the energy dampening system, and at 830 distributing the force through the energy dampening system. In some embodiments, the applied force is a localized force such as a projectile contacting and impacting a ballistic plate disposed adjacent to the energy dampening system.

FIG. 12 illustrates a method 900 for dispersing kinetic energy, according to an embodiment of the present disclosure. Method 900 may include at 910 providing a pair of the energy dampening systems as described above in footwear and between the footwear and the feet of the wearer of the footwear, and at 920 distributing forces from the feet of the wearer through the energy dampening system.

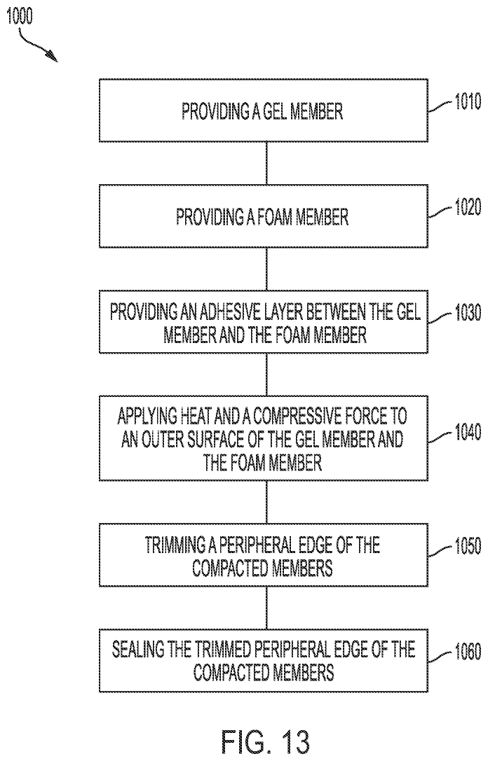

FIG. 13 illustrates a method 1000 for forming an energy dampening system, according to an embodiment of the present disclosure. Method 1000 may include at 1010 providing a gel member, at 1020 providing an aerated gel member, at 1030 providing an adhesive layer between the gel member and the aerated gel member, at 1040 applying heat and a compressive force to an outer surface of the gel member and the aerated gel member, at 1050 trimming a peripheral edge of the compacted members, and at 1060 sealing the trimmed peripheral edge of the compacted members.

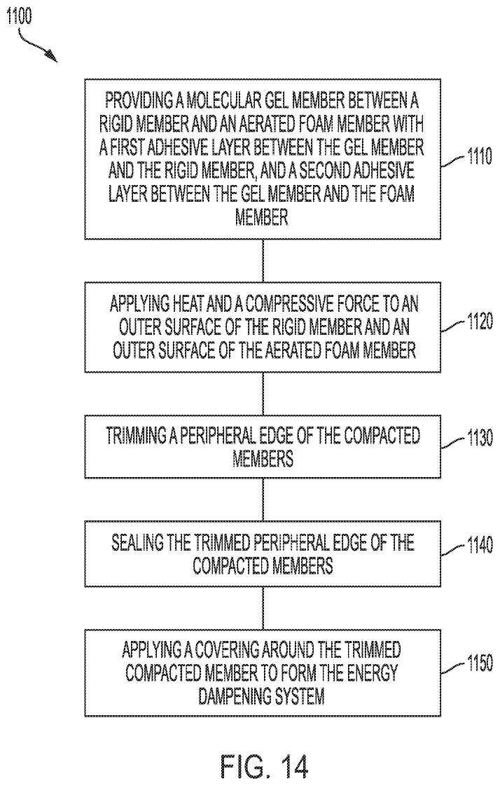

FIG. 14 illustrates a method 1100 for forming an energy dampening system, according to an embodiment of the present disclosure. Method 1100 may include at 1110 providing a molecular gel member between a support structure and an aerated gel member with a first adhesive layer between the gel member and the support structure, and a second adhesive layer between the gel member and the aerated gel member, at 1120 applying heat and a compressive force to an outer surface of the support structure and an outer surface of the aerated gel member, at 1130 trimming peripheral edge of the compacted members, at 1140 sealing the trimmed peripheral edge of the compacted members, and, optionally, at 1150 applying a covering around the trimmed compacted member to form the energy dampening system.

By way of example and without limitation thereto, one exemplary embodiment of method 1100 may include, at step 1110, providing a rigid or semi-rigid support structure, such as an ABS blank having a nominal thickness of approximately 0.062 inches with haircell texture on one side (surface). Optionally, each ABS blank may then be heated in an oven set between about 760 and 770 degrees Fahrenheit with an oven dwell time of about 15 seconds to allow non-planar molding of the ABS blank.

Step 1110 may further include providing a gel member having a nominal thickness of approximately 0.125 inches. The gel member may include a removable liner covering an adhesive. Each gel member may be die cut to shape, as desired. Step 1110 may further include providing an aerated gel member having a nominal thickness of about 0.125 inches. An adhesive layer may be laminated onto the carrier side of the aerated gel member. The aerated gel member plus adhesive may then be die cut to shape, as desired.

At step 1120, the ABS blank is positioned haircell-side up and the removable liner on the gel member is removed whereby the gel member is placed atop the ABS blank haircell surface. The adhesive layer and aerated gel is then placed atop the gel member so as to form a laminate of ABS blank/adhesive/gel member/adhesive/aerated gel member. Bonding pressure of the laminate is applied under a 20 ton topical press for a length of about 1.5 seconds.

Step 1150 may further include laminating a ripstop fabric with an adhesive. In one embodiment, the ripstop fabric has a gloss side and a textured side. Critically, the adhesive must be laminated on the gloss side of the ripstop fabric to avoid lamination failure. The laminated blank formed in step 120 is then laminated between layers of ripstop fabric via the ripstop adhesive layer.

It will be appreciated from the present disclosure that the energy dampening systems may be applicable as trauma pads used by law enforcement and military personnel underneath their body armor/plate carrier system. The energy dampening pads or trauma pads may be operable conjunctively or in incorporation with ballistic armor and protective garments of many types. The present disclose may aid in the protection of law enforcement and military personnel due to the weight reduction and the enhancement of projectile efficiency that have resulted in higher body armor deformation and therefore, an increasing risk of blunt trauma effects.

As may be recognized by those of ordinary skill in the art based on the teachings herein, numerous changes and modifications may be made to the above-described and other embodiments of the present invention without departing from the scope of the invention. The energy dampening systems and/or components thereof as disclosed in the specification, including the accompanying abstract and drawings, may be replaced by alternative component(s) or feature(s), such as those disclosed in another embodiment, which serve the same, equivalent or similar purpose as known by those skilled in the art to achieve the same, equivalent or similar results by such alternative component(s) or feature(s) to provide a similar function for the intended purpose. In addition, the devices and apparatus may include more or fewer components or features than the embodiments as described and illustrated herein. Accordingly, this detailed description of the currently-preferred embodiments is to be taken as illustrative, as opposed to limiting the invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has”, and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements, but is not limited to possessing only those one or more steps or elements. Likewise, a step of a method or an element of a device that “comprises,” “has,” “includes,” or “contains” one or more features possesses those one or more features, but is not limited to possessing only those one or more features. Furthermore, a device or structure that is configured in a certain way is configured in at least that way, but may also be configured in ways that are not listed.

The disclosure has been described with reference to the preferred embodiments. It will be understood that the architectural and operational embodiments described herein are exemplary of a plurality of possible arrangements to provide the same general features, characteristics, and general apparatus operation. Modifications and alterations will occur to others upon a reading and understanding of the preceding detailed description. It is intended that the disclosure be construed as including all such modifications and alterations.

What is claimed is:

1. An energy dampening and/or dispersing system comprising:
a gel member having a top surface and a bottom surface; and
an aerated gel member having a top surface and a bottom surface, said top surface of said aerated gel member secured to said bottom surface of said gel member.

2. The energy dampening and/or dispersing system of claim 1 further comprising:
a support structure having a top surface and a bottom surface, said top surface of said molecular gel member secured to said bottom surface of said support structure; and
a cover extending over said top surface of said support structure and said bottom surface of said aerated gel member.

3. The energy dampening and/or dispersing system of claim 1 wherein said gel member is operable to transfer forces primary in a first direction, and said aerated gel member is operable to transfer forces primary in a second direction different from said first direction.

4. The energy dampening and/or dispersing system of claim 1 wherein said gel member is in tension and said aerated gel member is in compression.

5. The energy dampening and/or dispersing system of claim 2 wherein said support structure comprises a rigid or semi-rigid material.

6. The energy dampening and/or dispersing system of claim 5 wherein said support structure comprises an acrylonitrile-butadiene-styrene (ABS) plastic material.

7. The energy dampening and/or dispersing system of claim 2 wherein said cover comprises a ripstop nylon fabric.

8. The energy dampening and/or dispersing system of claim 2 further comprising a first adhesive member for securing said bottom side of said support structure to said top surface of said gel member, and a second adhesive member for securing said bottom surface said gel member to said top surface of said aerated gel member.

9. The energy dampening and/or dispersing system of claim 2 wherein said support structure, said gel member, and said aerated gel member comprise aligned peripheral edges, and further comprising a seal secured to said peripheral edges.

10. The energy dampening and/or dispersing system of claim 1 wherein said energy dampening and/or dispersing system comprises a thickness of ¼ inch to ½ inch.

11. The energy dampening and/or dispersing system of claim 2 wherein said support structure has a thickness of 0.062 inch, said gel member comprises a thickness of 0.125 inch, said aerated gel member has a thickness of about 0.18 inch, and said cover comprises a thickness of about 0.1 inch.

12. The energy dampening and/or dispersing system of claim 2 further comprising a ballistic plate and a garment for carrying said energy dampening and/or dispersing system and said ballistic plate.

13. A method for dispersing kinetic energy, the method comprising:
providing an energy dampening and/or dispersing system comprising a gel member having a top surface and a bottom surface; and an aerated gel member having a top surface and a bottom surface, wherein said top surface of said aerated gel member is secured to said bottom surface of said gel member;
receiving a force applied to the energy dampening and/or dispersing system; and
distributing the force across the energy dampening and/or dispersing system.

14. The method of claim 13 wherein the applying the force comprises applying a localized force to the energy dampening and/or dispersing system.

15. The method of claim 13 wherein the energy dampening and/or dispersing system is positioned between a ballistic plate and a user and the force is distributed across the energy dampening and/or dispersing system in response to impact of a projectile onto the ballistic plate.

16. A method for forming an energy dampening and/or dispersing system, the method comprising:
providing a gel member;
providing an aerated gel member;
providing an adhesive layer between the gel member and the aerated gel member;
applying heat and a compressive force to an outer surface of the gel member and the aerated gel member;
trimming a peripheral edge of the compacted members; and
sealing the trimmed peripheral edge of the compacted members.

17. A method for forming an energy dampening and/or dispersing system, the method comprising:
providing a molecular gel member between a support structure and an aerated gel member with a first adhesive layer between the gel member and the support structure, and a second adhesive layer between the gel member and the aerated gel member;
applying heat and a compressive force to an outer surface of the support structure and an outer surface of the aerated gel member;
trimming a peripheral edge of the compacted members;
sealing the trimmed peripheral edge of the compacted members;
applying a covering around the trimmed compacted member to form the energy dampening and/or dispersing system.
